(19) United States
(12) Patent Application Publication
(10) Pub. No.: US 2026/0274524 A1
(43) Pub. Date: Sep. 17, 2026

(54) PIVOTING DRINKWARE CLOSURE WITH MAGNETIC DEVICE MOUNT

(71) Applicant: Alexander J. Avey, Newport Beach, CA (US)

(72) Inventor: Alexander J. Avey, Newport Beach, CA (US)

(21) Appl. No.: 19/673,193

(22) Filed: May 11, 2026

Related U.S. Application Data
(63) Continuation-in-part of application No. 30/014,338, filed on Jul. 22, 2025.
(63) Continuation-in-part of application No. 29/993,079, filed on Mar. 12, 2025, now Pat. No. D1128362.
(60) Provisional application No. 63/803,242, filed on May 9, 2025.

(51) Int. Cl. B65D 47/12; F16M 11/14

(52) U.S. Cl. CPC B65D 47/122; F16M 11/14

(57) ABSTRACT

A drinkware closure assembly includes a housing with a socket portion and a coupling base portion that engages a beverage container. A ball seated within the socket portion forms a multi-axis articulation joint. A mounting platform has a tapered neck coupled to the ball, the neck narrowing toward the ball, a mounting surface for receiving a mobile device or accessory, and a magnetic module. The ball-and-socket joint allows the mounting platform to be repositioned in multiple axes while the beverage container remains stationary. A central structural core extends through at least a portion of the mounting platform, tapered neck, and ball, transferring tensile loads toward the coupling base portion. A fluid control seal separates a mechanical zone of the articulation assembly from a fluid zone of the coupling base portion. The coupling base portion may include an offset straw port or a clean-core hydration configuration.

### CROSS-REFERENCE TO RELATED APPLICATIONS

This application claims the benefit of U.S. Provisional Patent Application No. 63/803,242, filed May 9, 2025, entitled “Magnetic Ball-and-Socket Hydration Lid,” the entire disclosure of which is incorporated herein by reference.

This application is related to U.S. Design Patent Application No. Ser. No. 29/993,079, filed Mar. 12, 2025, entitled “Bottle Lid with Magnetic Stand,” and U.S. Design Patent Application No. Ser. No. 30/014,338, filed Jul. 22, 2025, entitled “Tumbler Lid with Magnetic Mount,” the entire disclosures of which are incorporated herein by reference.

### BACKGROUND OF THE INVENTION

This invention relates generally to portable drinkware accessories, and more particularly to an integrated drinkware closure system combining multi-axis device mounting capabilities with hydration functionality for dynamic, motion-based environments.

Mobile device users engaged in fitness training, outdoor recreation, travel, and content creation frequently desire hands-free video recording, viewing, or device positioning while maintaining access to hydration. Existing solutions present significant limitations. Vehicle-mounted systems and freestanding tripods require rigid attachment to fixed surfaces and lack portability. Simple bottle-top phone holders suffer from deficiencies including limited positioning freedom, inadequate structural stability under dynamic conditions, compromised leak resistance, and obstruction of drinking interfaces.

Prior art bottle-top mounts also often lack robust retention mechanisms to maintain device orientation during movement. Gravitational forces and inertial loads can cause mounted devices to drift or disengage. Existing designs frequently provide minimal friction interfaces without incorporating stabilizing structures, torque-control features, or ergonomic adjustment mechanisms for reliable positioning during active use. Furthermore, such mounts typically accommodate only a single bottle threading standard and provide no convenient way to refill, clean, insert ice, or access optional hydration components without complete disassembly.

Accordingly, there exists a need for an integrated drinkware closure system that combines multi-axis device mounting with reliable hydration functionality, maintains device orientation during dynamic use, accommodates diverse drinkware interfaces, preserves leak resistant sealing, and enables ergonomic one-handed adjustment.

### SUMMARY OF THE INVENTION

In one aspect, the present invention provides a drinkware closure assembly comprising a housing having a socket portion and a coupling base portion configured to engage a beverage container, a ball received within the socket portion to form a multi-axis articulation joint, and a mounting platform having a tapered neck coupled to the ball, a mounting surface, and a magnetic module housed therein, wherein the neck narrows toward the ball.

In certain embodiments, the coupling base portion comprises threading configured to engage a beverage container, including internal threading, external threading, or both. In certain embodiments, the closure assembly further comprises a fluid control seal disposed within the housing between the ball-and-socket joint and the coupling base portion to separate a mechanical zone from a fluid zone. In certain embodiments, the closure assembly further comprises a straw port disposed in the coupling base portion at a lateral offset from a central axis of the mounting platform to define an offset fluid path that bypasses a central mechanical axis. In certain embodiments, the closure assembly further comprises a retention collar disposed within the socket portion and capturing the ball while permitting multi-axis articulation. In certain embodiments, the closure assembly further comprises a central rod extending through at least a portion of the mounting platform, tapered neck, and ball to a lower anchor point within the coupling base portion, thereby transmitting tensile load through an internal structural core. In certain embodiments, the closure assembly further comprises an accessory loop disposed on the housing.

In certain embodiments, the closure assembly comprises a modular internal stack or universal pivot core configured such that one or more internal pivot, seal, or fluid-control components may be removed, replaced, upgraded, or reconfigured without redesigning an outer housing geometry. The closure assembly may have a no-straw clean-core embodiment, a straw-based embodiment, or a deployable spout embodiment sharing a common ball-and-socket and mounting architecture.

These and other features, aspects and advantages of the present invention will become better understood with reference to the following drawings, description, and claims.

### BRIEF DESCRIPTION OF THE DRAWINGS

FIG. 1 is a bottom rear perspective view of a closure assembly according to a first embodiment of the present invention;

FIG. 2 is a front elevational view thereof;

FIG. 3 is a sectional view thereof, taken along line 3-3 of FIG. 2;

FIG. 4 is a right side elevational view thereof, shown in use with a mobile device coupled to the mounting platform;

FIG. 5 is a bottom rear perspective view of a closure assembly according to a second embodiment of the present invention;

FIG. 6 is a front elevational view thereof;

FIG. 7 is a sectional view thereof, taken along line 7-7 of FIG. 6;

FIG. 8 is a cutaway perspective view illustrating the internal support and seal stack of a ball-and-socket joint assembly according to an embodiment of the present invention;

FIG. 9 is a sectional view illustrating a modular coupling base interface according to an embodiment of the present invention;

FIG. 10 is a sectional view of a closure assembly according to an embodiment of the present invention; and

FIG. 11 is a sectional view illustrating an offset lateral fluid path and straw configuration according to another embodiment of the present invention.

### DETAILED DESCRIPTION OF THE INVENTION

The following detailed description is of exemplary embodiments of the invention and is not to be taken in a limiting sense. The scope of the invention is defined by the appended claims.

Broadly, one embodiment of the present invention is a drinkware closure assembly comprising a mounting platform having a device-coupling interface including at least one magnetic element, a ball element coupled to the mounting platform and received within a socket housing to form a multi-axis articulation joint, and a coupling base configured to engage a beverage container. In certain embodiments, a central structural core, spine, rod, stem, or tension member extends through at least a portion of the mounting platform, tapered neck, and ball element to a lower anchor region within the coupling base, thereby establishing a load path that transfers tensile forces from the mounting platform toward the coupling base while reducing stress on outer shell components.

The ball element may be positioned with an exposed upper region above an upper retaining structure such that the center of rotation is elevated relative to a retention collar, thereby permitting an expanded cone of articulation compared to more deeply captive socket constructions. In certain embodiments, the ball is substantially spherical. In certain embodiments, the ball may include flats, partial spherical regions, bores, inserts, overmolded portions, or attachment features for cooperation with a central structural core or adjoining neck structure.

In certain embodiments, the coupling base may incorporate internal threading, external threading, or both, enabling compatibility with one or more beverage container standards with or without an adapter. In other embodiments, the coupling base may engage a beverage container through a non-threaded engagement interface, including press-fit engagement, friction-fit engagement, plug-fit engagement, snap-fit engagement, gasket-band engagement, elastomeric ring engagement, compression-seal engagement, or other non-threaded coupling arrangement. In certain embodiments, the closure assembly may further define a central access opening or refill opening for adding liquid, adding ice, or cleaning without full removal of the closure assembly from a beverage container.

The hydration architecture may take multiple forms. The coupling base portion may be configured as a clean-core or no-straw embodiment. In other embodiments, the coupling base portion includes a straw port at an anterior or lateral offset position relative to the central axis of the mounting platform and ball-and-socket assembly. The straw port may accommodate a rigid straw, flexible tube, semi-rigid spout, telescoping straw, deployable straw, flip-up straw, pivoting straw, or other hydration conduit. A sealing valve, grommet, diaphragm, or compressible seal may surround the port to limit liquid egress whether or not a straw is installed. Vent features may optionally be provided.

In certain embodiments, the offset fluid path bypasses the central mechanical axis, thereby preserving a structurally separated load path and fluid path. Such separation may reduce contamination of internal pivot components by liquid, improve serviceability, and permit incorporation of an internal structural core without obstructing hydration functionality.

The magnetic module may comprise one or more disc magnets, ring magnets, stacked magnets, segmented magnets, magnetic arrays, ferromagnetic plates, or combinations thereof. The magnetic module may be configured for compatibility with MagSafe-standard accessories or analogous magnetic attachment ecosystems. In certain embodiments, the magnetic module is positioned so that the mounted device remains substantially centered relative to the pivot region throughout a range of movement, thereby reducing drift under gravitational loading.

The socket portion may include a socket cavity, socket seat, liner, friction interface, retention collar, retaining ring, retaining lip, support plate, washer, and/or biasing element. In certain embodiments, one or more friction liners formed from self-lubricating acetals, elastomers, silicone, thermoplastic elastomers (TPE), nylon, or other low-friction or controlled-friction materials may be interposed between the ball and surrounding socket structure to tune holding torque or rotational resistance without materially altering the outer geometry of the socket housing.

In certain embodiments, a biasing element may be provided below or adjacent the ball element and socket seat to maintain engagement and resist unintended movement. The biasing element may comprise a spring washer, wave spring, compression spring, elastomeric member, resilient ring, preload insert, or other force-applying member. In certain embodiments, an adjustable tension structure such as a threaded collar, compression ring, cam feature, or set screw may permit selective modification of holding torque.

In certain embodiments, the central structural core may be fixed relative to the mounting platform and move with the upper assembly while the ball articulates within the socket. In other embodiments, the core may pass through a bore or attachment feature associated with the ball element and cooperate with one or more bushings, bearings, keyed structures, or bonded interfaces. The precise manner in which the core couples to the mounting platform, neck, ball, and lower anchor may vary by embodiment provided that the assembly preserves articulated movement while transmitting at least a portion of tensile load through an internal structural path.

A tapered, horn-shaped, parabolic, or otherwise narrowed neck may extend between the mounting platform and the ball element. This neck may serve as an ergonomic grip for one-handed adjustment, a thermal-safe region isolating the user from hot or cold container temperatures, a carrying region, and a structural transition that distributes load from the mounting platform toward the ball element and central structural core.

In certain embodiments, the coupling base further includes a primary container seal, such as a compression gasket, rim gasket, O-ring, labyrinth seal, radial seal, face seal, or combination thereof. In certain embodiments, the coupling base may further include indexing features, multi-start threads, dual-thread interfaces, variable-pitch thread profiles, or detent elements configured to provide repeatable orientation when engaged with a beverage container.

In certain embodiments, the closure assembly includes an internal fluid barrier or fluid control seal disposed below the ball-and-socket joint and above the lower fluid region of the coupling base. The fluid control seal may comprise a molded diaphragm, elastomeric membrane, gasket, lip seal, overmolded barrier, or other fluid-isolating structure configured to separate a mechanical zone of the articulation assembly from a fluid zone associated with beverage flow.

In certain embodiments, a support structure, intermediate housing core, or tiered base support flange is disposed below the ball-and-socket joint and cooperates with the fluid control seal. This support structure may define a stepped or tiered architecture, receive replaceable components, support a universal pivot core, define one or more seal seats, or integrate the lower socket housing with the coupling base.

In certain embodiments, the coupling base portion is configured as a modular lower interface that may be substituted with an alternative coupling base portion, e.g., configured for a different engagement standard, or reconfigured, e.g., through an adapter or convertible interface to engage beverage containers having different engagement standards, independently of the upper mounting and articulation assembly. The upper assembly comprises the mounting platform, magnetic module, tapered neck, ball-and-socket joint, socket housing, and internal seal stack. The upper assembly may remain common across coupling base configurations while the coupling base portion is adapted to engage beverage containers having different engagement standards, including internal threads, external threads, wide-mouth profiles, narrow-mouth profiles, multi-start threads, variable-pitch threads, indexed threads, adapter-style interfaces, press-fit interfaces, friction-fit interfaces, plug-fit interfaces, snap-fit interfaces, gasket-band interfaces, elastomeric ring interfaces, compression-seal interfaces, or other threaded or non-threaded beverage-container engagement geometries. This architecture permits the magnetic mounting and articulation functionality to be deployed across diverse drinkware platforms without redesigning the primary structural and functional components of the assembly.

In certain embodiments, the assembly is configured as a modular internal stack or modular flex ecosystem in which one or more internal components, including the pivot core, seal stack, straw conduit, fluid barrier, liner, washer, or tensioning components, may be selectively interchanged, serviced, or upgraded while preserving a common external form factor. Such modularity permits different embodiments, including no-straw, fixed-straw, deployable-straw, side-port, and enhanced articulation configurations.

In certain embodiments, the closure assembly may include an auxiliary pivot interface, secondary articulation region, or compliant support interface disposed at or near the transition between the tapered neck and the mounting platform. This auxiliary pivot interface permits minor angular adjustment and self-leveling of the mounting platform without materially altering the exterior profile of the assembly. The auxiliary pivot interface may comprise a thinned or radiused neck region, a recessed pivot seat, a low-profile articulating element, or other compliant structure disposed along the longitudinal axis between the mounting platform and the primary ball-and-socket joint. In certain embodiments, one or more structural cores or internal reinforcement members extend through the auxiliary pivot interface region.

Optional auxiliary features may include an accessory loop, lanyard connection point, carabiner interface, tether point, illumination element, charging feature, decorative trim, texture features, grip ribs, or indexing marks.

Rigid components may be formed from engineering thermoplastics, including polycarbonate, Acrylonitrile Butadiene Styrene (ABS), nylon, polypropylene, acetal, or blends thereof. Seals and soft-touch components may be formed from food-grade silicone, thermoplastic elastomers (TPE), thermoplastic polyurethane (TPU), ethylene propylene diene monomer (EPDM), or other elastomeric materials. Magnetic components may include neodymium magnets and associated magnetic flux guidance structures. Components in contact with liquid are preferably food-safe and free of undesirable contaminants.

Manufacturing may employ injection molding, overmolding, insert molding, ultrasonic welding, compression molding, adhesive bonding, threaded assembly, snap-fit engagement, press-fit engagement, or combinations thereof.

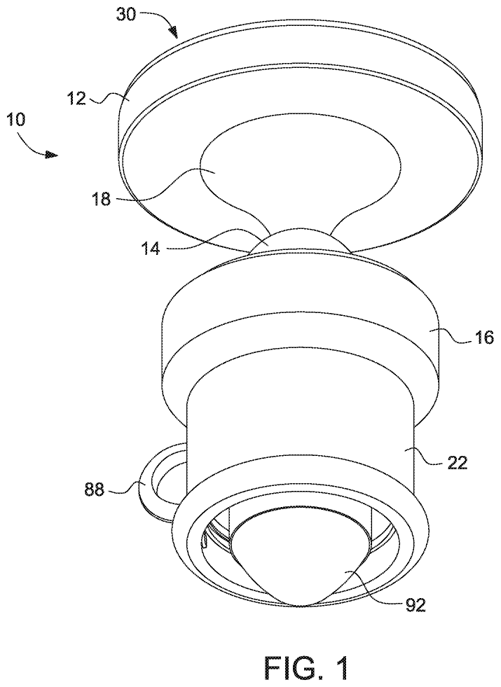

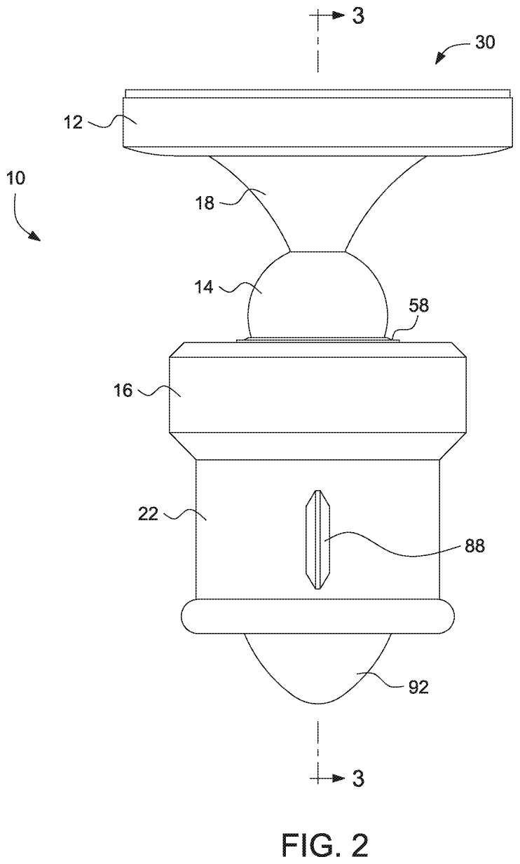

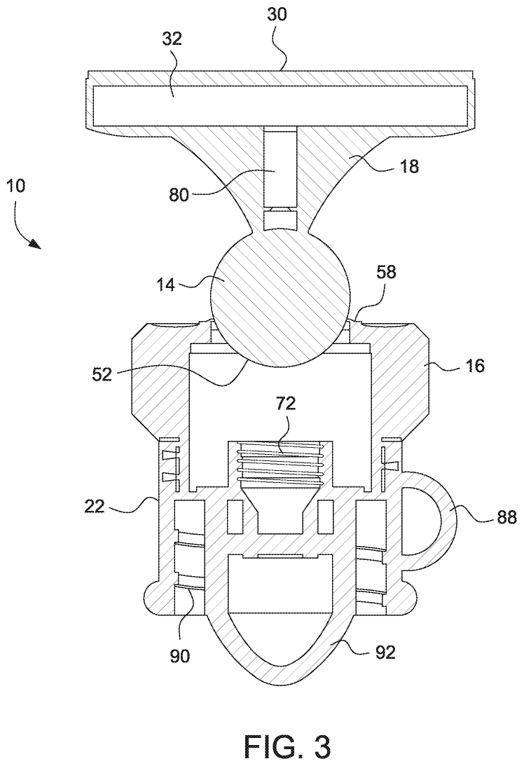

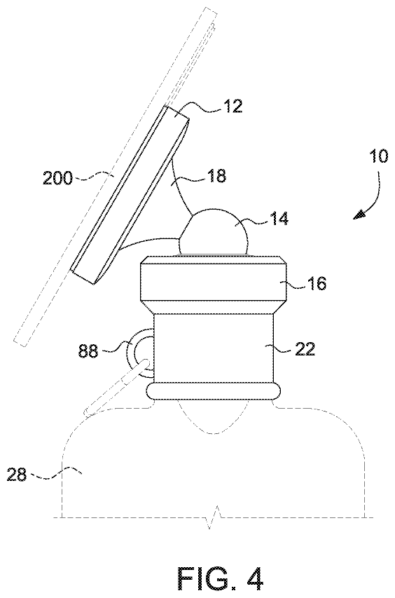

Referring now to FIGS. 1-4, a first embodiment of a closure assembly 10 comprises a mounting platform 12, a ball element 14, a socket housing 16, a tapered neck 18, and a coupling base 22.

The mounting platform 12 provides a mounting surface 30 configured to support a mobile device 200 or magnetic accessory. A magnetic module 32 is housed within or adjacent the mounting platform 12.

The ball element 14 is received within a socket cavity 52 of the socket housing 16. A retention collar 58, retaining ring, or analogous retaining structure captures the ball element while permitting multi-axis articulation. A socket seat liner, washer, or support surface may be disposed below or around the ball element 14. In certain embodiments, a preload or biasing element 72 is disposed below or adjacent the socket seat 70.

The tapered neck 18 extends between the mounting platform 12 and the ball element 14. In certain embodiments, the neck 18 and mounting platform 12 are integrally formed. In other embodiments, they may be separately formed and joined by mechanical fastening, bonding, insert molding, or overmolding.

A central structural core or rod 80 extends from the mounting platform 12 through at least a portion of the neck 18 and toward a lower anchor region within the coupling base 22. In certain embodiments, the rod 80 extends through or is fixed relative to the ball element 14. In certain embodiments, the rod cooperates with a lower anchor, insert, or support structure such that tensile loads applied at the mounting platform 12 are transmitted into the coupling base 22 through the internal structural core.

The coupling base 22 engages a beverage container 28 via a threaded bottle interface 90. A compression gasket or other primary seal may be disposed at or near the container engagement region. An accessory loop 88 may be provided on the coupling base 22 or adjacent housing structure.

In handheld use, a user may grip the beverage container 28 and/or tapered neck 18 while a mobile device 200 remains magnetically supported on the mounting platform 12. The ball-and-socket joint permits multi-axis adjustment of the mounted device while the beverage container remains stationary or hand-held.

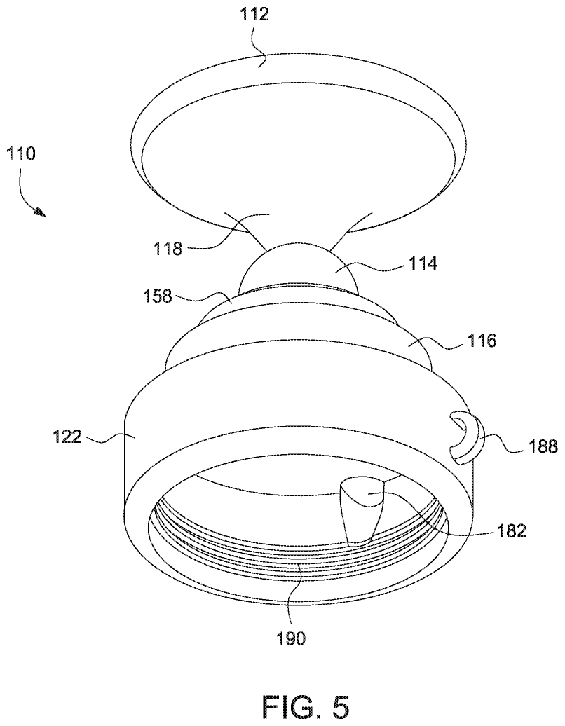

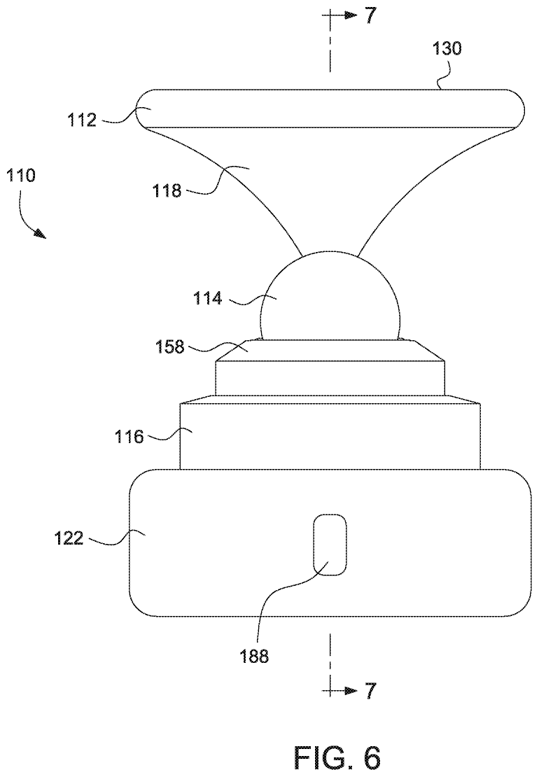

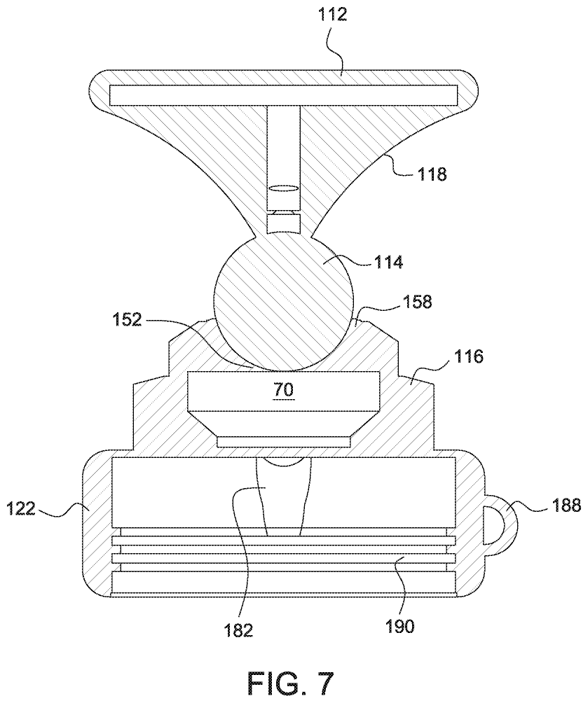

Referring to FIGS. 5-7, a second embodiment of a closure assembly 110 includes substantially the same articulation and mounting architecture as the first embodiment but further includes an offset straw port 182 associated with a straw-based hydration system.

A straw, tube, or spout may extend through the straw port 182 along an offset fluid path that bypasses the central mechanical axis. A sealing grommet or valve may surround the straw port 182.

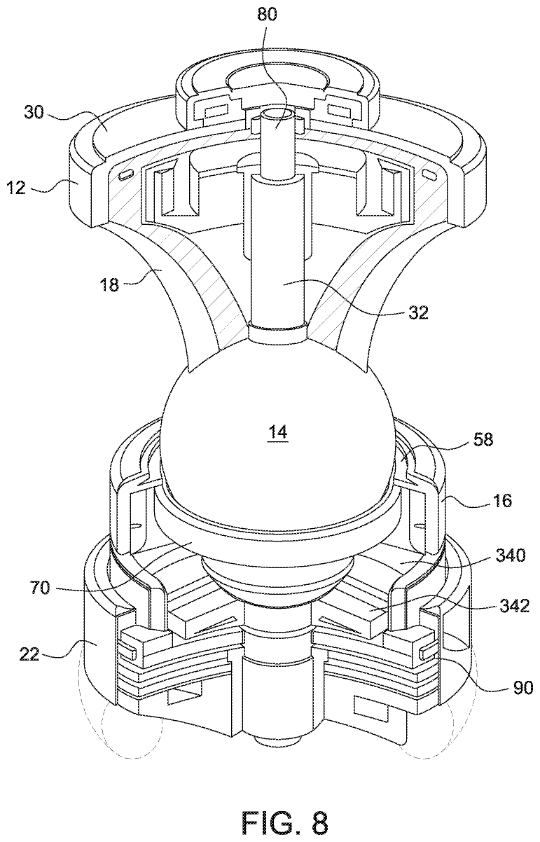

FIG. 8 illustrates the internal architecture of the ball-and-socket region and internal support and seal stack. The central rod 80 extends from the mounting platform 12 through the tapered neck 18 and toward the ball element 14. The retention collar 58 captures the ball element 14 within the socket cavity 52. Below the ball element 14, the assembly may include a socket seat 70, a preload or biasing element 72, a fluid control seal 340, and an intermediate housing core or support structure 342 arranged in series. The fluid control seal 340 separates the mechanical zone associated with the articulation assembly from the fluid zone of the coupling base 22.

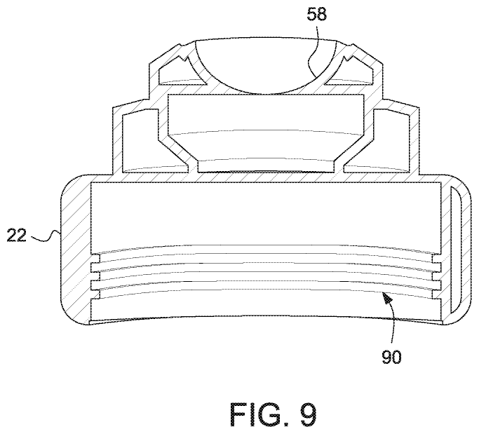

FIG. 9 shows the coupling base 22 in isolation, defining a modular lower interface including the threaded bottle interface 90 and an internal support structure disposed within the housing above the threaded interface. The coupling base 22 may be substituted with an alternative coupling base configured for a different engagement standard, or reconfigured through an adapter or convertible interface, to engage beverage containers having different engagement standards, including internal threads, external threads, wide-mouth profiles, narrow-mouth profiles, variable-pitch threads, or adapter-style interfaces, without redesigning the upper mounting and articulation assembly.

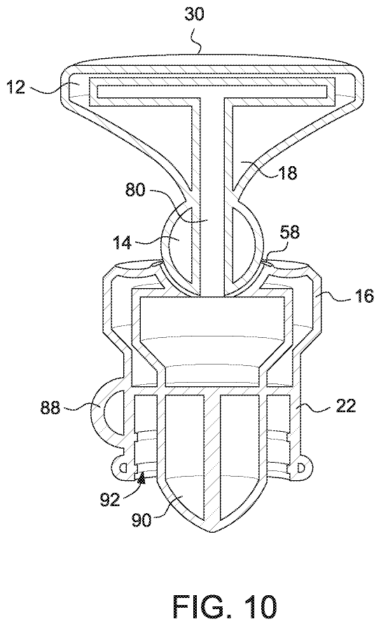

In the embodiment of FIG. 10, the complete closure assembly including the mounting platform 12, magnetic module 32, tapered neck 18, central rod 80, ball element 14, retention collar 58, socket housing 16, coupling base 22, accessory loop 88, and conical lower tip 92. The central rod 80 extends from the mounting platform 12 through the tapered neck 18 and ball element 14 to a lower anchor region within the coupling base 22, establishing an internal load path through the assembly.

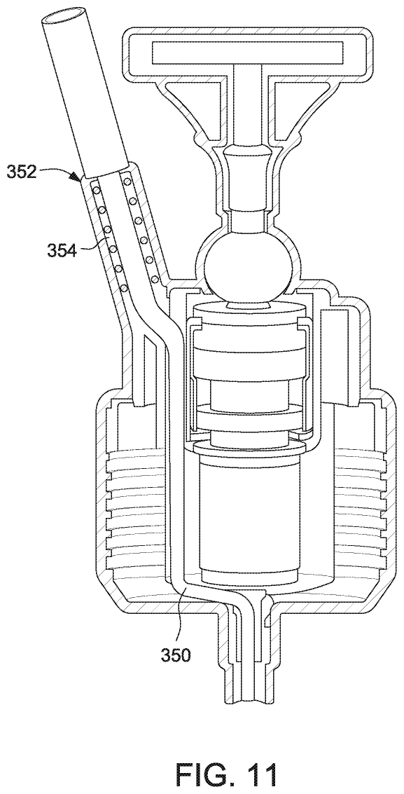

An offset fluid path embodiment is illustrated in FIG. 11, including an offset fluid channel 350 extending along an interior sidewall of the housing and a lateral straw port 352 disposed at an offset from the central axis through which a straw or fluid conduit extends. A sealing grommet 354 surrounds the straw port 352. The mechanical zone, including the ball element 14, retention collar 58, socket housing 16, and internal seal stack, is fully separated from the fluid path, which routes along the sidewall and around the central mechanical axis. The mounting platform 12, magnetic module 32, tapered neck 18, central rod 80, coupling base 22, and conical lower tip 92 are also shown.

It should be understood that the foregoing relates to exemplary embodiments of the invention and that modifications may be made without departing from the spirit and scope of the invention as set forth in the following claims.

What is claimed is:

1. A drinkware closure assembly comprising:
a housing having a socket portion and a coupling base portion configured to engage a beverage container;
a ball received within the socket portion to form a multi-axis articulation joint; and
a mounting platform having a tapered neck coupled to the ball, a mounting surface, and a magnetic module housed therein, wherein the tapered neck narrows toward the ball.

2. The drinkware closure assembly of claim 1, wherein the coupling base portion comprises threading selected from the group consisting of internal threading, external threading, and a combination of internal and external threading.

3. The drinkware closure assembly of claim 1, further comprising a fluid control seal disposed within the housing between the ball and the coupling base portion.

4. The drinkware closure assembly of claim 3, further comprising a support structure disposed between the fluid control seal and the coupling base portion.

5. The drinkware closure assembly of claim 1, further comprising a straw port disposed in the coupling base portion at a lateral offset from a central axis of the mounting platform.

6. The drinkware closure assembly of claim 5, further comprising a seal surrounding the straw port.

7. The drinkware closure assembly of claim 5, further comprising a fluid conduit extending through the straw port selected from the group consisting of a straw, a spout, and a tube.

8. The drinkware closure assembly of claim 1, further comprising a retention collar disposed within the socket portion and capturing the ball while permitting multi-axis articulation.

9. The drinkware closure assembly of claim 8, further comprising a socket seat disposed within the socket portion below the ball.

10. The drinkware closure assembly of claim 9, further comprising a biasing element disposed below or adjacent the socket seat.

11. The drinkware closure assembly of claim 1, wherein the socket portion comprises a friction interface providing frictional resistance to rotation of the ball.

12. The drinkware closure assembly of claim 1, further comprising a central structural core extending through at least a portion of the mounting platform, the tapered neck, and the ball.

13. The drinkware closure assembly of claim 12, wherein the central structural core extends to a lower anchor point within the coupling base portion.

14. The drinkware closure assembly of claim 1, further comprising an accessory loop disposed on the housing.

15. The drinkware closure assembly of claim 1, wherein the coupling base portion defines a fluid path that is offset laterally from a central mechanical axis of the multi-axis articulation joint.

16. The drinkware closure assembly of claim 1, wherein the housing includes a modular internal stack configured to receive one or more removable components.

17. The drinkware closure assembly of claim 1, wherein the coupling base portion is free of a straw.

18. The drinkware closure assembly of claim 1, wherein the coupling base portion comprises a thread profile selected from the group consisting of variable-pitch and indexed.

19. The drinkware closure assembly of claim 1, further comprising a secondary articulation interface disposed proximal to a transition between the tapered neck and the mounting platform and configured to permit angular adjustment supplemental to the multi-axis articulation joint.
